(19) United States
(12) Patent Application Publication
(10) Pub. No.: US 2019/0111974 A1
(43) Pub. Date: Apr. 18, 2019

(54) VEHICLE SIDE SECTION STRUCTURE

(71) Applicant: TOYOTA JIDOSHA KABUSHIKI KAISHA, Toyota-shi (JP)

(72) Inventors: Junichi TAKAYANAGI, Nagoya-shi (JP); Toshihisa MIURA, Kariya-shi (JP)

(73) Assignee: TOYOTA JIDOSHA KABUSHIKI KAISHA, Toyota-shi (JP)

(21) Appl. No.: 16/141,472

(22) Filed: Sep. 25, 2018

(30) Foreign Application Priority Data
Oct. 13, 2017 (JP) 2017-199245

(51) Int. Cl. B62D 25/04; B62D 29/02

(52) U.S. Cl. CPC B62D 25/04; B62D 29/02

(57) ABSTRACT

A vehicle side section structure includes a center pillar and a reinforcement member. The center pillar is provided at a vehicle front-rear direction central portion of a vehicle side section and extends in a vehicle vertical direction. The reinforcement member is formed of wood, is provided within a cross-section of the center pillar, and is oriented in a direction in which an axially central direction of annual growth rings of the wood of the reinforcement member runs along the vehicle vertical direction.

### CROSS-REFERENCE TO RELATED APPLICATION

This application is based on and claims priority under 35 USC 119 from Japanese Patent Application No. 2017-199245 filed on Oct. 13, 2017, the disclosure of which is incorporated by reference herein.

### BACKGROUND

### Technical Field

The present disclosure relates to a vehicle side section structure.

### Related Art

International Publication (WO) No. 2011/030463 discloses a structure in which a center pillar reinforcing patch is attached to center pillar outer reinforcement configuring a center pillar. Moreover, Japanese Patent Application Laid-Open (JP-A) No. 2014-184899 discloses a structure in which a wooden shock absorbing member is provided to a crash box portion between a vehicle side section structure and a side member. In JP-A No. 2014-184899, an axially central direction of annual growth rings of the shock absorbing member is aligned with the axial direction of the crash box (the vehicle front-rear direction), such that the shock absorbing member crushes more readily along the axial direction.

In the vehicle side section structure disclosed in WO No. 2011/030463, cross-sectional collapse of the center pillar is suppressed by the center pillar reinforcing patch. However, there is room for improvement from the perspective of dispersing collision load and suppressing localized deformation of the center pillar in a side-on collision. Increasing the sheet thickness of the vehicle side section structure itself would enable localized deformation of the center pillar to be suppressed, but would also lead to an increase in weight.

### SUMMARY

The present disclosure provides a vehicle side section structure that may suppress localized deformation of a center pillar while suppressing an increase in weight.

A vehicle side section structure according to a first aspect includes a center pillar and a reinforcement member. The center pillar is provided at a vehicle front-rear direction central portion of a vehicle side section and extending in a vehicle vertical direction. The reinforcement member is formed of wood, is provided within a cross-section of the center pillar, and is oriented in a direction in which an axially central direction of annual growth rings of the wood of the reinforcement member runs along the vehicle vertical direction.

In the vehicle side section structure of the first aspect, the center pillar is provided at the vehicle front-rear direction central portion of the vehicle side section, and the center pillar extends in the vehicle vertical direction. The reinforcement member is disposed within the cross-section of the center pillar, and the reinforcement member is formed of wood. Note that the axially central direction of the annual growth rings of the wood of the reinforcement member is oriented in a direction running along the vehicle vertical direction. Load may accordingly be dispersed along the axial center direction of the annual growth rings. Thus, even in the event of a colliding body colliding with the center pillar, collision load may be dispersed in the vehicle vertical direction, and the local deformation of the center pillar may be suppressed.

Moreover, due to forming the reinforcement member of wood, an increase in the weight may be suppressed in comparison to cases in which the sheet thickness of the center pillar is increased, or the like. Note that the axial center direction of the annual growth rings referred to herein refers to a direction along the center axis of the annual growth rings of the wood in a state prior to being cut.

In a second aspect of the present disclosure, in the first aspect, a lower end portion of the reinforcement member may be positioned at a belt line height.

In the vehicle side section structure of the second aspect, the reinforcement member is not disposed in a region at the vehicle lower side of the belt line, where the center pillar has a comparatively high ability to withstand load, thereby enabling a reduction in the weight of the center pillar to be achieved. At the vehicle upper side of the belt line, a large cross-section area cannot be secured for the center pillar due to a door frame and the like being disposed in this region. Thus, by disposing the reinforcement member in this region, the ability of the center pillar to withstand load may be increased, and localized deformation of the center pillar may be suppressed.

In a third aspect of the present disclosure, in the first aspect or the second aspect, an upper end portion of the reinforcement member may be positioned at a connection portion between the center pillar and a roof-side rail.

In the vehicle side section structure of the third aspect, the upper end portion of the reinforcement member is positioned at the connection portion between the center pillar and the roof-side rail, thereby enabling collision load to be effectively transmitted to the roof-side rail through the reinforcement member.

The vehicle side section structure according to the first aspect may suppress local deformation of the center pillar while suppressing an increase in weight.

The vehicle side section structure according to the second aspect may reduce the weight while suppressing localized deformation, in comparison to structures in which the reinforcement member is disposed in the entirety of the center pillar.

The vehicle side section structure according to the third aspect may transmit collision load toward the roof-side rail.

### BRIEF DESCRIPTION OF THE DRAWINGS

Exemplary embodiments of the present disclosure will be described in detail based on the following figures, wherein:

FIG. 1 is a side view illustrating a side section of a vehicle to which a vehicle side section structure according to an exemplary embodiment has been installed;

FIG. 2 is a plan view cross-section sectioned along line 2-2 in FIG. 1; and

FIG. 3 is an enlarged cross-section sectioned along line 3-3 in FIG. 1.

### DETAILED DESCRIPTION

Explanation follows regarding a vehicle side section structure according to an exemplary embodiment, with reference to the drawings. Note that in the drawings, the arrow FR, the arrow UP, and the arrow OUT respectively indicate a front direction, upward direction, and vehicle width direction outer side of a vehicle, as appropriate. In the following explanation, unless specifically stated otherwise, reference simply to front, rear, upward, downward, left, and right directions refer to the front and rear in a vehicle front-rear direction, upward and downward in a vehicle vertical direction, and left and right in a vehicle width direction when facing a direction of forward travel.

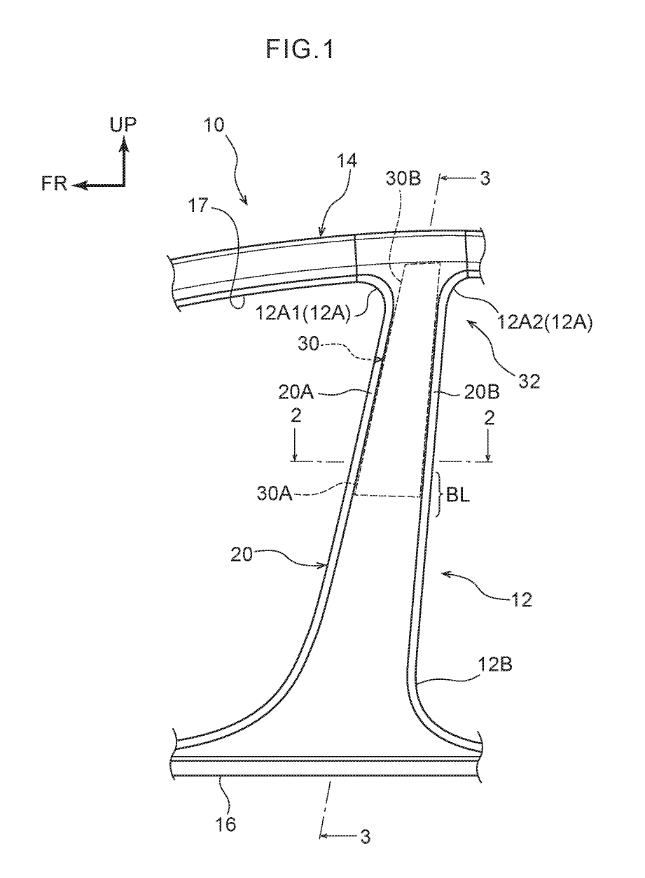

As illustrated in FIG. 1, a side section of a vehicle 10 applied with the vehicle side section structure is provided with a center pillar 12 that extends in the vehicle vertical direction. Note that center pillars 12 are provided on both vehicle width direction sides. However, since the center pillars 12 are configured with left-right symmetrical structures, the following explanation concerns only the center pillar 12 on the left side of the vehicle, and explanation regarding the center pillar on the right side of the vehicle is omitted.

The center pillar 12 extends in the vertical direction at a vehicle front-rear direction central portion of the vehicle side section. An upper end portion 12A of the center pillar 12 (a front widened portion 12A1 and a rear widened portion 12A2) are connected to a roof-side rail 14 extending along the vehicle front-rear direction. A lower end portion 12B of the center pillar 12 is formed with a greater vehicle front-rear direction width than the upper end portion, and is connected to a rocker 16 extending along the vehicle front-rear direction. A region enclosed by the center pillar 12, the roof-side rail 14, and the rocker 16 configures an opening 17 of a side door. A side door, not illustrated in the drawings, is attached in the opening 17. Note that in FIG. 1, BL indicates a belt line, and the belt line BL indicates an upper end portion of a door panel configuring the side door, not illustrated in the drawings. In other words, the belt line BL corresponds to a lower end portion of a side window, not illustrated in the drawings.

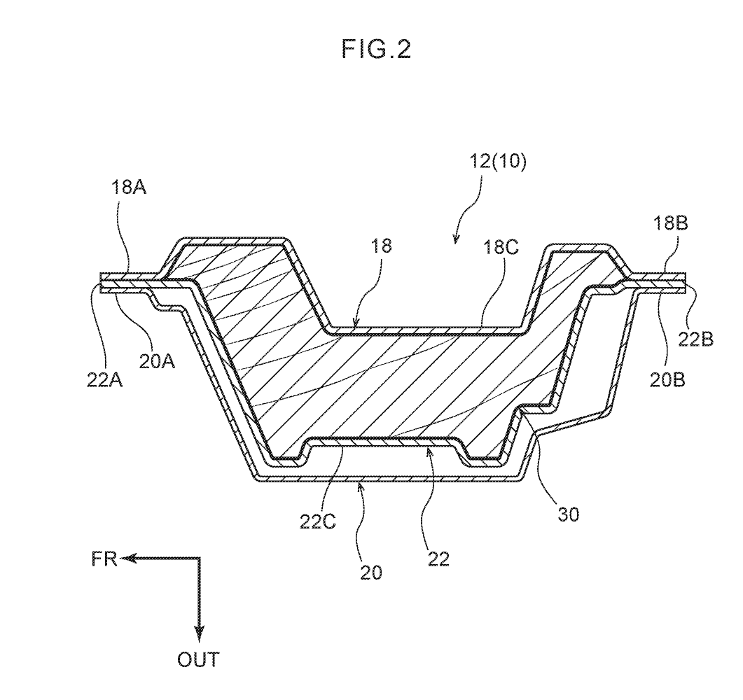

As illustrated in FIG. 2, the center pillar 12 is configured including a pillar inner panel 18, a pillar outer panel 20, and pillar outer reinforcement 22. The pillar inner panel 18 is positioned at the inner side of the vehicle, and is formed by pressing a rigid sheet. Note that an inner front flange 18A extends from a front end portion of the pillar inner panel 18 toward the vehicle front, and an inner rear flange 18B extends from a rear end portion of the pillar inner panel 18 toward the vehicle rear. A recess 18C where the pillar inner panel 18 bulges toward the vehicle width direction outer side is formed between the inner front flange 18A and the inner rear flange 18B.

The pillar outer panel 20 is positioned at the vehicle width direction outer side of the pillar inner panel 18. The pillar outer panel 20 is formed by pressing a rigid sheet that is thinner than the pillar inner panel 18. The pillar outer panel 20 is formed with a substantially hat shaped cross-section profile opening toward the vehicle width direction inner side, and an outer front flange 20A extends from a front end portion of the pillar outer panel 20 toward the vehicle front. Moreover, an outer rear flange 20B extends from a rear end portion of the pillar outer panel 20 toward the vehicle rear.

The pillar outer reinforcement 22 (referred to hereafter as pillar outer RF 22) is disposed between the pillar inner panel 18 and the pillar outer panel 20 so as to run along the pillar outer panel 20. The pillar outer RF 22 is formed by pressing a rigid sheet of similar thickness to the pillar inner panel 18, and is formed with a substantially hat shaped cross-section profile opening toward the vehicle width direction inner side. A RF front flange 22A extends from a front end portion of the pillar outer RF 22 toward the vehicle front. Moreover, an RF rear flange 22B extends from a rear end portion of the pillar outer RF 22 toward the vehicle rear. The inner front flange 18A, the outer front flange 20A, and the RF front flange 22A are superimposed on one another, and are joined to each other by spot welding or the like. The inner rear flange 18B, the outer rear flange 20B, and the RF rear flange 22B are also superimposed on one another, and are joined to each other by spot welding or the like. In this manner, the center pillar 12 is configured with a closed cross-section structure. A reinforcement member 30 is provided within the closed cross-section structure configured by the pillar inner panel 18 and the pillar outer RF 22. The reinforcement member 30 will be described in detail later.

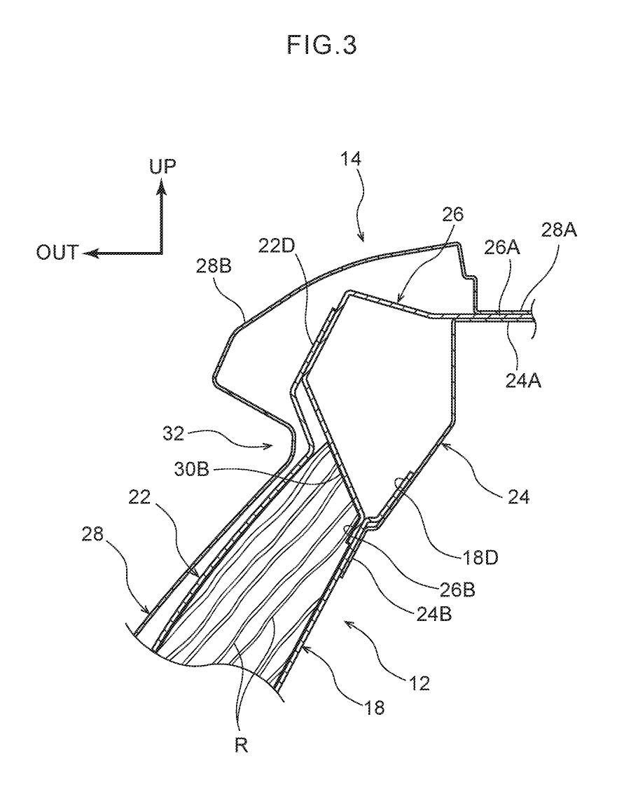

As illustrated in FIG. 3, the roof-side rail 14 is configured including a rail inner panel 24 and a rail outer panel 26. The rail inner panel 24 is formed by pressing a rigid sheet, and extends along the vehicle vertical direction. An inner inward flange 24A extends from an upper end portion of the rail inner panel 24 toward the vehicle width direction inner side, and an inner outward flange 24B extends from a lower end portion of the rail inner panel 24 toward the vehicle width direction outer side and the vehicle lower side.

The rail outer panel 26 is formed by pressing a rigid sheet, and is formed with a substantially hat shaped cross-section profile opening toward the vehicle width direction inner side and the vehicle lower side. An outer inward flange 26A extends from an upper end portion of the rail outer panel 26 toward the vehicle width direction inner side, and an outer outward flange 26B extends from a lower end portion of the rail outer panel 26 toward the vehicle width direction outer side and the vehicle lower side. The inner inward flange 24A and the outer inward flange 26A are superimposed on one another, and are joined to each other by spot welding or the like. The inner outward flange 24B and the outer outward flange 26B are also superimposed on one another, and are joined to each other by spot welding or the like. The roof-side rail 14 is thus configured with a closed cross-section structure.

Note that an upper end portion 22D of the pillar outer RF 22 is superimposed on an outer face of the rail outer panel 26, and is joined thereto by spot welding or the like. An upper end portion 18D of the pillar inner panel 18 enters the closed cross-section of the roof-side rail 14, is superimposed on the rail inner panel 24, and is joined thereto by spot welding or the like.

A side outer panel 28 is provided at the vehicle outer side of the roof-side rail 14. The side outer panel 28 is formed by pressing a rigid sheet. A side inward flange 28A extends from a vehicle width direction inner side end portion of the side outer panel 28 toward the vehicle width direction inner side. The side inward flange 28A is superimposed on an upper face of the outer inward flange 26A, and is joined to both the inner inward flange 24A and the outer inward flange 26A by spot welding or the like. A projection 28B projects toward the vehicle outer side at a vehicle width direction outer side of the side inward flange 28A of the side outer panel 28. The side outer panel 28 extends from a lower end portion of the projection 28B toward the vehicle lower side, following the pillar outer RF 22.

The reinforcement member 30 is made of wood, and is provided within the closed cross-section of the center pillar 12. As an example, in the present exemplary embodiment, the reinforcement member 30 is formed of laminated wood. As illustrated in FIG. 1, the reinforcement member 30 is formed in a block shape with its length direction in the vehicle vertical direction, and is provided in a region spanning from the belt line BL to a connection portion 32 between the center pillar 12 and the roof-side rail 14. A lower end portion 30A of the reinforcement member 30 is positioned at the height of the belt line BL. An upper end portion 30B of the reinforcement member 30 is positioned at the connection portion 32 between the center pillar 12 and the roof-side rail 14. Note that the connection portion 32 is a location further toward the vehicle upper side than a lower end of a curved portion of the front widened portion 12A1 and a lower end of a curved portion of the rear widened portion 12A2.

As illustrated in FIG. 3, the upper end portion 30B of the reinforcement member 30 abuts the rail outer panel 26 of the roof-side rail 14. A vehicle width direction inner side end portion of the upper end portion 30B is notched commensurately to a step formed by the outer side outer flange 26B.

Moreover, as illustrated in FIG. 2, the reinforcement member 30 is pre-processed into a shape corresponding to the closed cross-section profile configured by the pillar inner panel 18 and the pillar outer RF 22. Accordingly, during assembly of the reinforcement member 30, the reinforcement member 30 is assembled so as to be sandwiched between the pillar inner panel 18 and the pillar outer RF 22. Note that the assembly method of the reinforcement member 30 to the center pillar 12 is not particularly limited, and, for example, the reinforcement member 30 may be fixed by screwing in bolts through the pillar inner panel 18. Moreover, the reinforcement member 30 may be fixed to the pillar inner panel 18 and pillar outer RF 22 using members such as clips.

Moreover, as illustrated in FIG. 3, an axial center direction of annual growth rings R of the wood configuring the reinforcement member 30 is oriented in a direction running along the vehicle vertical direction. Specifically, the axial center direction of the annual growth rings R is configured in a direction following the extension direction of the center pillar 12. The annual growth rings R accordingly extend in a direction along the pillar inner panel 18 and the pillar outer RF 22 as viewed in cross-section along the vehicle front-rear direction. Note that the direction running along the vehicle vertical direction referred to here is not limited to a direction parallel to the pillar inner panel 18 and the pillar outer RF 22, but rather is a broad concept including any directions running from the rocker 16 toward the roof-side rail 14.

Operation

Next, explanation follows regarding operation of the present exemplary embodiment.

In the vehicle side section structure of the present exemplary embodiment, as described above, the reinforcement member 30 is disposed within the closed cross-section of the center pillar 12, and the axial center direction of the tree rings R of the reinforcement member 30 runs in a direction following the vehicle vertical direction. Accordingly, for example, when collision load is input to the center pillar 12 in a direction toward the vehicle inner side in the event of a vehicle side-on collision, the collision load may be dispersed along the axial center direction of the tree rings R. Namely, the collision load may be dispersed in the vehicle vertical direction, enabling localized deformation of the center pillar 12 to be suppressed.

Moreover, due to forming the reinforcement member 30 of wood, an increase in the weight of the center pillar 12 (vehicle 10) may be suppressed in comparison to cases in which the sheet thickness of the center pillar 12 is increased, or cases in which metal patches or the like are attached to provide reinforcement. This thereby may suppress local deformation of the center pillar 12 while suppressing an increase in weight.

Moreover, in the present exemplary embodiment, as illustrated in FIG. 1, the reinforcement member 30 is not disposed in a region at the vehicle lower side of the belt line BL, where the center pillar 12 has a comparatively high ability to withstand load, thereby may reduce the weight of the center pillar 12 to be achieved. At the vehicle upper side of the belt line BL, a large cross-section area cannot be secured for the center pillar 12 due to a door frame and the like, not illustrated in the drawings, being disposed in this region. In the present exemplary embodiment, the ability of the center pillar 12 to withstand load may be increased, and localized deformation of the center pillar 12 may be suppressed, by disposing the reinforcement member 30 in this region. This thereby may reduce the weight while suppressing localized deformation in comparison to structures in which the reinforcement member 30 is disposed in the entirety of the center pillar 12.

Moreover, in the present exemplary embodiment, the upper end portion 30B of the reinforcement member 30 is positioned at the connection portion 32 between the center pillar 12 and the roof-side rail 14, thereby may transmit collision load to the roof-side rail 14 through the reinforcement member 30 in the event of a side-on collision. In particular, since the cross-section of the center pillar 12 is greater at the vehicle upper side of the front widened portion 12A1 and the rear widened portion 12A2, positioning the upper end portion 30B of the reinforcement member 30 at this portion may reinforce this portion, which has a lower ability to withstand load.

Moreover, in the present exemplary embodiment, as illustrated in FIG. 3, the upper end portion of the reinforcement member 30 abuts the rail outer panel 26 configuring the roof-side rail 14. This thereby may transmit collision load input to the reinforcement member 30 directly to the roof-side rail 14, and collision load to be dispersed along the vehicle front-rear direction along the roof-side rail 14.

Explanation has been given regarding a vehicle side section structure according to an exemplary embodiment. However, various implementations are obviously possible within a range not departing from the spirit of the present disclosure. For example, in the exemplary embodiment described above, a reinforcement member is formed in a block shape using laminated wood. However, there is no limitation thereto, and a reinforcement member may be formed using natural wood.

Moreover, in the present exemplary embodiment, the reinforcement member 30 is disposed only at the vehicle upper side of the belt line BL. However, there is no limitation thereto. For example, the reinforcement member 30 may be disposed across a region spanning from the rocker 16 to the roof-side rail 14. In such cases, the collision-withstand performance is improved at the vehicle lower side of the belt line BL, which enables collision-withstand performance to be secured and enables a reduction in costs, even when employing rigid sheets that have a lower tensile strength than the rigid sheets employed in structures lacking the reinforcement member 30.

Moreover, in the present exemplary embodiment, the pillar outer RF 22 is provided between the pillar inner panel 18 and the pillar outer panel 20, and the reinforcement member 30 is disposed within the closed cross-section formed by the pillar outer RF 22 and the pillar inner panel 18. However, there is no limitation thereto. For example, in a center pillar provided with a cross-section structure that does not include the pillar outer RF 22, the reinforcement member 30 may be disposed within a closed cross-section formed by the pillar inner panel 18 and the pillar outer panel 20.

What is claimed is:

1. A vehicle side-section structure comprising:
a center pillar provided at a vehicle front-rear direction central portion of a vehicle side-section and extending in a vehicle vertical direction; and
a reinforcement member formed of wood, the reinforcement member provided within a cross-section of the center pillar and oriented in a direction in which an axially central direction of annual growth rings of the wood of the reinforcement member runs along the vehicle vertical direction.

2. The vehicle side section structure of claim 1, wherein a lower end portion of the reinforcement member is positioned at a height of a belt line.

3. The vehicle side section structure of either claim 1, wherein an upper end portion of the reinforcement member is positioned at a connection portion between the center pillar and a roof-side rail.

4. The vehicle side section structure of claim 3, wherein the upper end portion of the reinforcement member abuts the roof-side rail.

5. The vehicle side section structure of claim 1, wherein the reinforcement member is formed of laminated wood.
